(19) United States
(12) Patent Application Publication
(10) Pub. No.: US 2025/0084963 A1
(43) Pub. Date: Mar. 13, 2025

(54) VAPOR COOLED REFILLABLE LOW-GRAVITY LIQUID ACQUISITION DEVICE

(71) Applicant: Blue Origin, LLC, Kent, WA (US)

(72) Inventors: Gary D. Grayson, Maple Valley, WA (US); Daniel A. Asturias, Seattle, WA (US); Victor Barackman, Corona, CA (US)

(21) Appl. No.: 18/465,696

(22) Filed: Sep. 12, 2023

(51) Int. Cl. F17C 13/00

(52) U.S. Cl. CPC F17C 13/008; F17C 2223/0161; F17C 2265/033; F17C 2270/0194

(57) ABSTRACT

Systems, a device, and methods of operating the device are disclosed. The device acquires cryogenic liquid in a tank in low-gravity and provides the liquid to an end user, such as a rocket engine. The device helps reduce vortex flows that tend to occur in tanks. The device, the liquid therein, and liquid in the tank may be cooled by a fluid flow from a thermodynamic vent or cryocooler. Such cooling may resultantly reduce pressure in the tank. Thus, the device may provide tank pressure control in space vehicles with cryogenic propellant. The device may have an annular shape that allows flow to a main tank output port to be substantially uninterrupted so as to have a relatively low pressure drop.

### BACKGROUND

In space, long duration missions generally require a capability to store and maintain propellant throughout the mission. Cryogenic propellants, such as liquid oxygen and liquid hydrogen, are difficult to maintain due to heating in space, which causes pressure changes and required venting due to these propellants boiling off. Such propellants in low-gravity also require special attention for drawing only the liquid phase of the propellants for an end-use, such as a rocket engine. Demand continues for a propellant cooling and liquid acquisition system that has relatively light mass, thermal efficiency, and simple manufacturability, while operating in the confines and limited resources involved in space flight.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is schematic view of a liquid acquisition cooling system, according to some embodiments.

FIG. 2 is a top view of a liquid acquisition device, according to some embodiments.

FIG. 3 is a cross-section view of a liquid acquisition device, according to some embodiments.

FIG. 4 is a perspective view of a liquid acquisition device, according to some embodiments.

FIG. 5 is a perspective view of a liquid acquisition device sans the enclosure manifold, according to some embodiments.

FIG. 6 is a perspective view of a liquid acquisition device sans an upper portion of the enclosure manifold, according to some embodiments.

FIG. 7 is a perspective view of a liquid acquisition device, according to other embodiments.

FIG. 8 is a perspective view of a liquid acquisition device sans the enclosure manifold, according to other embodiments.

FIG. 9 is a flow diagram of an example process of operating a liquid acquisition device in a low-gravity environment.

### DETAILED DESCRIPTION

This disclosure describes architectures and methods of operating a device that acquires liquid in a tank in low-gravity and provides the liquid to an end user, such as a rocket engine. The device helps reduce vortex flows that tend to occur in tanks. The device, the liquid therein, and liquid in the tank (but outside the device) may be cooled by a fluid flow from a thermodynamic vent (TVS) or cryocooler. Such cooling may resultantly reduce pressure in the tank. Thus, the device may provide tank pressure control in space vehicles with cryogenic propellant. The device may have an annular shape that allows flow to a main tank output port to be substantially uninterrupted so as to have a relatively low pressure drop.

Space vehicles, such as re-useable launch vehicles, often carry cryogenic fluids, such as liquid hydrogen and liquid oxygen, into space for use during a mission, either as a propellant or for power generation. Several problems generally arise in the storage and management of cryogenic fluids in space. For example, due to the relatively low temperature of a cryogenic fluid, heat may continuously transfer through walls of a tank and into the fluid. This heat transfer may cause the liquid phase of the fluid cryogen to boil, which creates a gas phase that increases the pressure inside the tank. Accordingly, tanks may be vented when the pressure reaches or exceeds a predetermined level. Another example problem involves an ability to acquire a single phase of the cryogenic fluid from the tank upon demand for use by the space vehicle, which generally uses liquid propellants for orbital maneuvering system engines, DC-power generation, and hydraulic operations, among other things. Thus, until substantially all the fluid has been depleted, an ability to withdraw only the liquid phase from the tank is important. On Earth, where gravity is significant, liquid is generally in a known location within the tank, specifically, settled against the tank's bottom with the gas phase thereabove. In a reduced-gravity environment, however, the absence of a significant gravitational force leads to liquid and gas phases that are generally free to move about inside the tank. In other words, the liquid phase may be “floating” about the tank distant from the liquid acquisition output ports (which may be at the “bottom” of the tank). Thus, fluid movement under reduced-gravity conditions generally hinders acquisition and withdrawal of fluids from a tank. Such fluid movement may also hinder vent operations of the space vessel. A vent system may be most efficient if only the gas phase is vented from the vessel. For example, expulsion of a liquid phase of a propellant through a space vessel's vent system may unnecessarily waste the propellant (e.g., a cryogenic liquid) without significantly reducing the pressure inside the tank. As described herein, a liquid acquisition device in a tank may, among other things, efficiently supply liquid propellants to various systems of a space vehicle (e.g., such as rocket engines) while minimizing propellant boil-off and venting from the tank so as not to waste propellant and prevent venting of liquid-phase propellants.

In embodiments described herein, a liquid acquisition cooling system for operating in a low-gravity environment may include a cryogenic tank and a liquid acquisition device that is located in the cryogenic tank. The liquid acquisition device may comprise a toroid-shaped (e.g., an annular shaped) enclosure having a top facing a central portion of the cryogenic tank and a bottom that is opposite the top. Herein, “toroid-shaped enclosure”, “enclosure, and “enclosure manifold” are used interchangeably, having the same meaning. The liquid acquisition cooling system may include a high-flow fluid port that is coincident with the central axial opening of the toroid-shaped enclosure. The high-flow fluid port is separated from the interior of the enclosure of the liquid acquisition device by a manifold and/or screens. The high-flow fluid port may be configured to provide fluid from the cryogenic tank to an external device, such as a rocket engine, that consumes the fluid as a fuel or oxidizer. The high-flow fluid port may allow the fluid, destined for the external device, to bypass the enclosure of the liquid acquisition device. Because the high-flow fluid port is relatively large (e.g., the size of the opening of the toroid-shaped enclosure), the fluid flow therethrough need not experience a pressure drop and thus will not contribute to a pressure delta between the tank and the external device (e.g., a main engine). In contrast to high flow to an external device, fluid from inside the enclosure may flow to one or more thermodynamic vents that are part of the liquid acquisition cooling system, as described below.

The liquid acquisition cooling system may further include screens, which may be substantially flat, having pores that are sized to substantially prevent flow of a gas phase of the fluid while allowing flow of a liquid phase of the fluid. “Substantially prevent flow of a gas phase” means that a relatively small portion of the fluid in the gas phase may pass through the screens. The screens may be positioned around at least a portion of an outer perimeter of the toroid-shaped enclosure. In some implementations, screens may also be positioned around at least a portion of an inner perimeter of the toroid-shaped enclosure. Except for the pores of the screens, the toroid-shaped enclosure of the liquid acquisition device may be sealed to separate fluid that is outside the enclosure from fluid that is inside the enclosure (the latter fluid having entered the enclosure via the screen pores). During operation, the fluid in the cryogenic tank enters the enclosure via the screens.

The liquid acquisition cooling system may further include a first exit port in the enclosure at or near the bottom of the enclosure, a second exit port in the enclosure at or near the top of the enclosure, and a primary thermodynamic vent to receive the fluid that is substantially in the liquid phase from the first exit port. “Substantially in the liquid phase” means that a relatively small portion of the fluid may be in the gas phase. The first exit port may be configured to draw the fluid that is substantially in the liquid phase from the enclosure while the second exit port may be configured to draw the fluid that is substantially in the gas phase from the enclosure. “Substantially in the gas phase” means that a relatively small portion of the fluid may be in the liquid phase. The primary thermodynamic vent may be configured to reduce the pressure and temperature of the fluid that is substantially in the liquid phase, thus producing a cooled fluid.

In some embodiments, the liquid acquisition cooling system may further include a secondary thermodynamic vent to receive the fluid that is substantially in the gas phase from the second exit port. A bleed valve may be located upstream from the secondary thermodynamic vent. The system may include the bleed valve to receive the fluid that is substantially in the gas phase from the second exit port. A first heat exchanger, configured to receive the cooled fluid from the primary thermodynamic vent, may be located in or on the cryogenic tank. A second heat exchanger may be located in the enclosure and may be configured to receive the cooled fluid from the primary thermodynamic vent. The second heat exchanger may be upstream from the first heat exchanger. In some implementations, the primary and secondary thermodynamic vents may be a Joule-Thompson throttling device or a cryocooler. For example, a Joule-Thompson throttling device may cool a gas or liquid when the gas or liquid is forced through a valve or porous plug while keeping this process thermally insulated so that no heat is exchanged with the environment. Each of the thermodynamic vents may comprise a large diameter high pressure drop orifice with a series of “levels” that act as individual orifices, for example.

The liquid acquisition device may include antivortex wing vanes that protrude into the cryogenic tank from the toroid-shaped enclosure. The liquid acquisition device may further include an antivortex/vapor ingestion suppressor in the central axial opening of the toroid-shaped enclosure and between the high-flow fluid port and the central portion of the cryogenic tank.

In some embodiments, a liquid acquisition device for operating in a low-gravity environment may include a ring-shaped conduit (e.g., pipe, duct, line, tube) to collect fluid that is substantially in the liquid phase within a toroid-shaped enclosure of the device. The ring-shaped conduit may be substantially concentric with a perimeter of the toroid-shaped enclosure and at or near a bottom of the enclosure. A second ring-shaped conduit to collect the fluid substantially in the gas phase within the enclosure may be substantially concentric with the perimeter of the toroid-shaped enclosure and at or near a top, opposite the bottom, of the enclosure.

In some embodiments, a method of operating a liquid acquisition device in a low-gravity environment includes imparting an acceleration to a space vehicle in which the liquid acquisition device is located within a cryogenic tank. The acceleration allows a fluid in the tank to settle toward an end of the tank and at least partially into the liquid acquisition device (e.g., via screens). The method also includes opening a bleed valve to allow a gas-phase portion of the fluid to exit the liquid acquisition device via a port and enabling the gas-phase portion of the fluid to pass through a thermodynamic vent that lowers the pressure and temperature of the gas-phase portion of the fluid to produce a cooled gas. In some implementations, the method includes allowing the cooled gas to pass through a heat exchanger in or on the cryogenic tank. A second heat exchanger carrying the cooled gas may be located in the liquid acquisition device. Further method steps may include allowing a liquid-phase portion of the fluid to exit the liquid acquisition device via a second port and enabling the liquid-phase portion of the fluid to pass through a secondary thermodynamic vent.

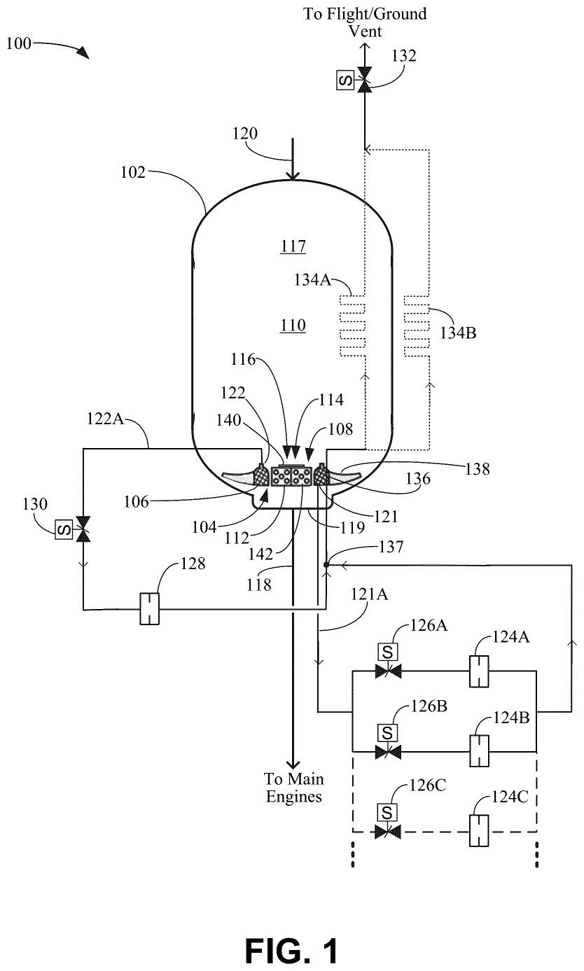

FIG. 1 is schematic view of a liquid acquisition cooling system 100, according to some embodiments. Liquid acquisition cooling system 100, configured to operate in a low-gravity (e.g., micro-gravity) environment, such as that experienced in a space vehicle, may include a cryogenic tank 102 and a liquid acquisition device 104 that is located in the cryogenic tank. Liquid acquisition device 104 may comprise a toroid-shaped enclosure 106 having a top 108 facing a central portion 110 of cryogenic tank 102 and a bottom 112 that is opposite the top. Liquid acquisition cooling system 100 may include a high-flow fluid port 114 that is coincident with the central axial opening 116 of toroid-shaped enclosure 106. High-flow fluid port 114 may be configured to provide fluid 117 from cryogenic tank 102 to an external device, such as one or more main engines of the space vehicle, for example, that consume the liquid phase of fluid 117 as a fuel or oxidizer. This fluid may flow to a conduit 118 at the bottom of a sump 119 in tank 102. Fluid 117 may be supplied to tank 102 via a supply port 120.

During operation of system 100, fluid 117 in cryogenic tank 102 enters enclosure 106, as described below in detail. Liquid acquisition device 104 may include a first exit port 121 in enclosure 106 at or near bottom 112 of the enclosure and a second exit port 122 in the enclosure at or near top 108 of the enclosure. First exit port 121 may lead to a line 121A (e.g., line, tube, conduit, pipe, etc.) and second exit port 122 may lead to a line 122A. Because the main function of line 121A is to carry a liquid phase of fluid 117, line 121A may be referred to as a liquid line, though it may carry both liquid and gas phases of the fluid. Because the main function of line 122A may be for bleeding a gas phase of fluid 117 from a top portion of the liquid acquisition device, line 122A may be referred to as a bleed line, though it may carry both liquid and gas phases of the fluid. First exit port 121 may be configured to draw the fluid that is substantially in the liquid phase from the enclosure while second exit port 122 may be configured to draw the fluid that is substantially in the gas phase from the enclosure. System 100 may include one or more primary thermodynamic vents 124A. 124B, 124C, etc. (collectively referred to as “124”) to receive the fluid that is substantially in the liquid phase from first exit port 121. One or more valves 126A, 126B, 126C, etc. (collectively referred to as “TVS valves 126”) may respectively control flow of the fluid to the one or more primary thermodynamic vents 124. These thermodynamic vents may be configured to reduce the pressure and temperature of the fluid that is substantially in the liquid phase, thus producing a cooled fluid. In some cases, either gas or liquid can enter the thermodynamic vents but the most cooling occurs with liquid, which will evaporate in the thermodynamic vent and absorb latent heat. In other words, the fluid may enter the thermodynamic vent as two phases, but the liquid phase is preferred for best cooling performance.

As described above and indicated in FIG. 1, system 100 may include one or more primary thermodynamic vents 124. A presence of more than one primary thermodynamic vent 124 may provide a benefit of a selectable cooling rate by selecting among the one or more primary thermodynamic vents 124. For example, 1000 watts of cooling may be required if the space vehicle is in a planform-to-sun orientation, which may require venting of hydrogen (H2) at a rate of 20 lbm (pound mass) per hour. Thus, a primary thermodynamic vent may be selected based on this rate. But only 300 watts of cooling may be required if the space vehicle is in a nose-to-sun orientation. In this case, if only one primary thermodynamic vent 124 rated for 1000 watts of cooling is present in system 100, then this primary thermodynamic vent may need to be cycled on and off (for example, by one of TVS valves 126) so as to cool at or around 300 watts. Alternatively, if more than one primary thermodynamic vent 124 is present in system 100, then individual primary thermodynamic vents, or combinations thereof, may be selected to operate to provide the desired level of cooling. For example, each of primary thermodynamic vents 124A and 124B may provide 300 watts of cooling and primary thermodynamic vent 124C may provide 1000 watts of cooling. Accordingly, if 300 watts of cooling are desired, then either one of vents 124A or 124B may be operated (e.g., via valves 126A or 126B). On the other hand, if 1000 watts of cooling are desired, then all of the vents 124A, 124B, and 124C may be operated. The implementation just described may have three or more circuits (e.g., one circuit corresponding to a vent 124 and a TVS valve 126), while other implementations may have any number of circuits, and claimed subject matter is not limited in this respect.

Liquid acquisition cooling system 100 may further include a secondary thermodynamic vent 128 to receive the fluid that is substantially in the gas phase from second exit port 122. One or more valves 130 may control flow of the fluid to primary thermodynamic vent 124. One or more valves 130 may be bleed valves, the operation of which is described below. A vent valve 132 may be located downstream from primary thermodynamic vent 124 and secondary thermodynamic vent 128 to vent the fluid that is substantially in the gas phase.

Liquid acquisition cooling system 100 may further include a first heat exchanger 134 configured to receive the cooled fluid from primary thermodynamic vent 124. Though illustrated as being in cryogenic tank 102, first heat exchanger 134 may instead be located in or among layers (e.g., insulating and structural layers) of the cryogenic tank shell. First heat exchanger 134 may cool fluid 117 in the tank by transferring heat from fluid 117 to the cooled fluid travelling from primary thermodynamic vent 124 to a flight/ground vent that may be located at or near the exterior of the space vehicle.

A second heat exchanger 136 may be located in enclosure 106 and may be configured to receive the cooled fluid from primary thermodynamic vent 124. In some implementations, the first and second heat exchangers may be configured to also receive the cooled fluid from secondary thermodynamic vent 128 via junction 137. Second heat exchanger 136, first passing through enclosure 106, may be upstream from first heat exchanger 134. Second heat exchanger 136 may remove heat from fluid within enclosure 106, resulting in a cooling of the fluid. In turn, heat conduction between the fluid in the tank, outside enclosure 106, and the cooler fluid within enclosure 106 may occur via thermally conductive antivortex wing vanes 138 that protrude into cryogenic tank 102 from enclosure 106. In some implementations, the primary and secondary thermodynamic vents may be a Joule-Thompson throttling device or a cryocooler.

The liquid acquisition device may further include an antivortex/vapor ingestion suppressor, which comprises a vapor ingestion suppressor 140 and antivortex wing vanes 142, in the central axial opening 116 of enclosure 106 and between high-flow fluid port 114 and central portion 110 of cryogenic tank 102. Each of vapor ingestion suppressor 140 and antivortex wing vanes 142 may be porous and/or include perforations (e.g., a series of holes).

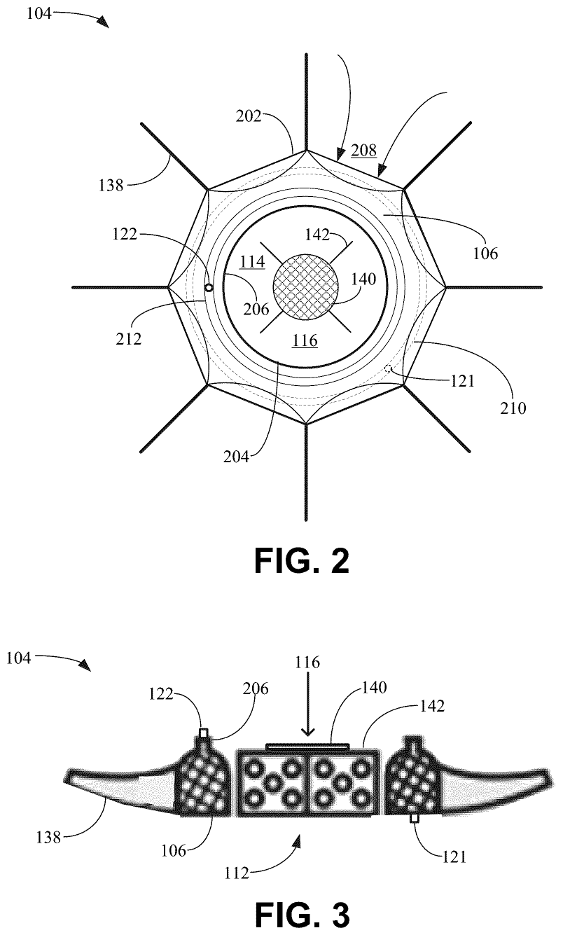

FIG. 2 is a top view of liquid acquisition device 104 and FIG. 3 is a cross-section view of the liquid acquisition device, according to various embodiments. Liquid acquisition device 104 includes toroid-shaped enclosure 106, which has as its central axial opening 116 high-flow fluid port 114 that may provide fluid from a cryogenic tank (e.g., 102) to an external device that consumes the fluid as a fuel or oxidizer. Liquid acquisition device 104 also includes screens 202 having pores that are sized to substantially prevent flow (e.g., via capillary forces) of a gas phase of the fluid and to substantially allow flow of a liquid phase of the fluid. The screens are positioned around at least a portion of an outer perimeter of toroid-shaped enclosure 106. In some implementations, an inner perimeter 204 may include screens 206 that are the same as or similar to screens 202. Screens 206, like screens 202, may be flat. During operation, the fluid (substantially in the liquid phase) in the cryogenic tank enters the enclosure via screens 202 and 206. For example, arrows 208 illustrate a possible general flow of fluid from the tank to inside enclosure 106.

Liquid acquisition device 104 also includes first exit port 121 through which primary thermodynamic vent 124 receives fluid, which is substantially in the liquid phase, from enclosure 106. Secondary thermodynamic vent 128 is configured to receive fluid, which is substantially in the gas phase, from the enclosure via second exit port 122. As mentioned above, one or more bleed valves 130 may be located downstream from the secondary thermodynamic vent to bleed the fluid, substantially in the gas phase, from the enclosure.

Though not illustrated in FIGS. 2 and 3, liquid acquisition device 104 may further include second heat exchanger 136 in enclosure 106 to receive cooled fluid from primary thermodynamic vent 124. Liquid acquisition device 104 may further include a ring-shaped conduit 210 to collect, from within enclosure 106, the fluid that is substantially in the liquid phase. The ring-shaped conduit (e.g., tube) may be substantially concentric with a perimeter of the toroid-shaped enclosure 106 and at or near bottom 112 of the enclosure. Additionally, a second ring-shaped conduit 212 may collect, from within enclosure 106, the fluid that is substantially in the gas phase. The second ring-shaped conduit (e.g., tube) may be substantially concentric with the perimeter of the toroid-shaped enclosure and at or near top 108 of the enclosure.

As mentioned above, liquid acquisition device 104 may include antivortex wing vanes 138 that protrude from toroid-shaped enclosure 106. The antivortex/vapor ingestion suppressor may comprise vapor ingestion suppressor 140 and antivortex wing vanes 142, which are located in central axial opening 116 of enclosure 106.

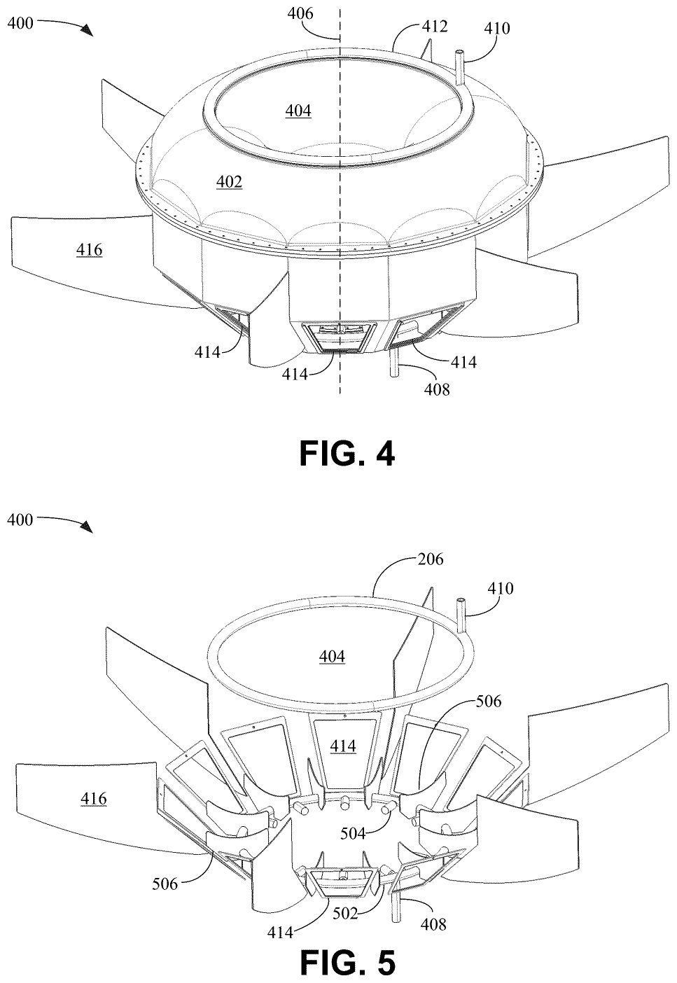

FIG. 4 is a perspective view of a liquid acquisition device 400, according to some embodiments. Device 400 may be similar to or the same as device 100, described above. For example, device 400 may operate in a cryogenic tank, such as 102. Liquid acquisition device 400 includes a toroid-shaped enclosure manifold 402, a high-flow fluid port 404 that is coincident with an opening about the central axis 406 of the toroid-shaped enclosure. Device 400 may further include a first exit port 408 in enclosure 402 at or near the bottom of the enclosure and a second exit port 410 in the enclosure at or near the top of the enclosure. A ring-shaped conduit 412 may collect, from within enclosure 402, the fluid that is substantially in the gas phase. The ring-shaped conduit may collect the fluid via one or more inlets (not illustrated) that extend from the ring-shaped conduit and into the immediate space of enclosure 402. During operation, this space is preferably occupied mostly (or almost completely) by the fluid in the gas phase that resides above the fluid's liquid phase nearer the bottom of the enclosure. The ring-shaped conduit (e.g., tube) may be substantially concentric with the perimeter of the toroid-shaped enclosure and at or near the top of the enclosure. Screens 414 may be positioned around at least a portion of an outer perimeter of toroid-shaped enclosure 402. Screens 414 may comprise pores that are sized to substantially prevent flow of a gas phase of a fluid and to substantially allow flow of a liquid phase of the fluid. The screens may be substantially flat (e.g., planar). Antivortex wing vanes 416 may protrude from toroid-shaped enclosure 402.

FIG. 5 is a perspective view of liquid acquisition device 400 sans enclosure manifold 402, according to some embodiments. This view provides visibility of a ring-shaped conduit 502 that collects, from within enclosure 402, the fluid that is substantially in the liquid phase. The ring-shaped conduit may be substantially concentric with the perimeter of the toroid-shaped enclosure. Ring-shaped conduit 502 may collect the fluid via one or more inlets 504 that extend from the ring-shaped conduit and into the space of enclosure 402. First exit port 408 provides an output for the fluid from ring-shaped conduit 502. This fluid, as described above, may then be provided to a thermodynamic vent (e.g., 124). During operation, the space in the region of ring-shaped conduit 502 is preferably occupied mostly (or almost completely) by the fluid in the liquid phase that resides below the fluid's gas phase nearer the top of the enclosure.

Liquid acquisition device 400 may further include an antivortex/vapor ingestion suppressor, which comprises a vapor ingestion suppressor (e.g., 140) and antivortex wing vanes 506, in the central axial opening of enclosure 406.

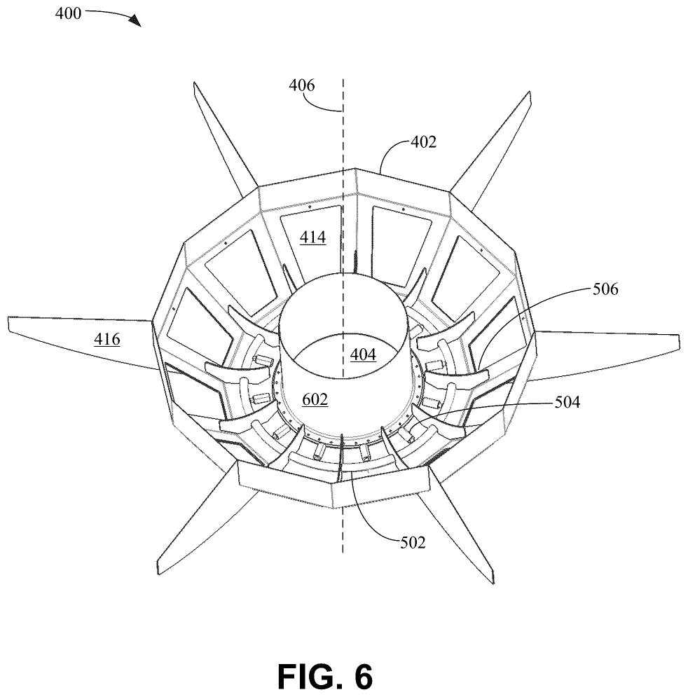

FIG. 6 is a perspective view of liquid acquisition device 400 sans an upper portion of enclosure 402, according to some embodiments. This view provides visibility of a manifold 602 that may partition the space of enclosure 402 from high-flow fluid port 404, which may be centered on central axis 406 of the toroid-shaped enclosure.

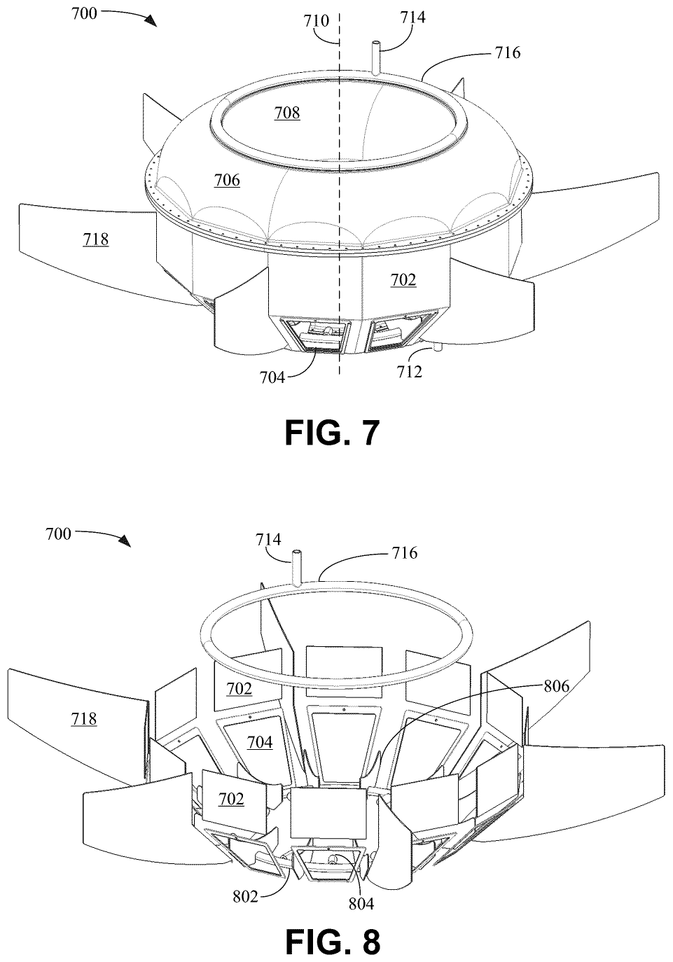

FIG. 7 is a perspective view of a liquid acquisition device 700, according to other embodiments. Device 700, which may operate in a cryogenic tank of a space vehicle, may be similar to device 104 or 400, described above. Device 700, however, includes, among other things, an additional row of screens 702. These screens may be located above a row of screens 704, for example. Liquid acquisition device 700 includes a toroid-shaped enclosure 706, a high-flow fluid port 708 that is coincident with an opening about the central axis 710 of the toroid-shaped enclosure. Device 700 may further include a first exit port 712 in enclosure 706 at or near the bottom of the enclosure and a second exit port 714 in the enclosure at or near the top of the enclosure. Second exit port 714 may receive fluid from a ring-shaped conduit 716 that collects, from within enclosure 706, the fluid that is substantially in the gas phase. The ring-shaped conduit may collect the fluid via one or more inlets (not illustrated) that extend from the ring-shaped conduit and into the immediate space of enclosure 706. During operation, this space is preferably occupied mostly (or almost completely) by the fluid in the gas phase that resides above the fluid's liquid phase nearer the bottom of the enclosure. The ring-shaped conduit may be substantially concentric with the perimeter of the toroid-shaped enclosure and at or near the top of the enclosure. Antivortex wing vanes 718 may protrude from toroid-shaped enclosure 402.

Screens 702 and 704 may be positioned around at least a portion of an outer perimeter of toroid-shaped enclosure 706. The screens may comprise pores that are sized to substantially prevent flow of a gas phase of a fluid and to allow flow of a liquid phase of the fluid. Screens may prevent gas from flowing through them by capillary pressure in what is called the bubble point pressure. If the pressure difference across the screen exceeds the bubble point pressure, then bubbles may be squeezed down and pushed through the screen pores. Thus, for example, the row of screens 702 may comprise pores that are optimally sized to substantially prevent flow of a gas phase (e.g., bubbles) of a fluid while allowing the liquid phase to pass. In such an arrangement, fluid in the gas phase may be at least partially trapped in the upper portion of enclosure 706, thus being prevented from escaping to the portion of the tank exterior to device 700. This gas phase may then be collected by one or more inlets (not illustrated) to conduit 716. The operation of this implementation may rely on the fluid being subjected to an acceleration of the space vehicle. In this situation, the liquid phase of the fluid tends to settle to the bottom of the tank and device 700, and the gas phase is displaced upward.

FIG. 8 is a perspective view of liquid acquisition device 700 sans enclosure 706, according to various embodiments. This view provides visibility of a ring-shaped conduit 802 that collects, from within enclosure 706, the fluid that is substantially in the liquid phase. The ring-shaped conduit may be substantially concentric with the perimeter of the toroid-shaped enclosure. Ring-shaped conduit 802 may collect the fluid via one or more inlets 804 that extend from the ring-shaped conduit and into the space of enclosure 706. First exit port 712 provides an output for the fluid from ring-shaped conduit 802. This fluid, as described above, may then be provided to a thermodynamic vent (e.g., 124). During operation, the space in the region of ring-shaped conduit 802 is preferably occupied mostly (or almost completely) by the fluid in the liquid phase that resides below the fluid's gas phase nearer the top of the enclosure.

Liquid acquisition device 700 may further include an antivortex/vapor ingestion suppressor, which comprises a vapor ingestion suppressor (e.g., 140) and antivortex wing vanes 806, in the central axial opening of enclosure 706.

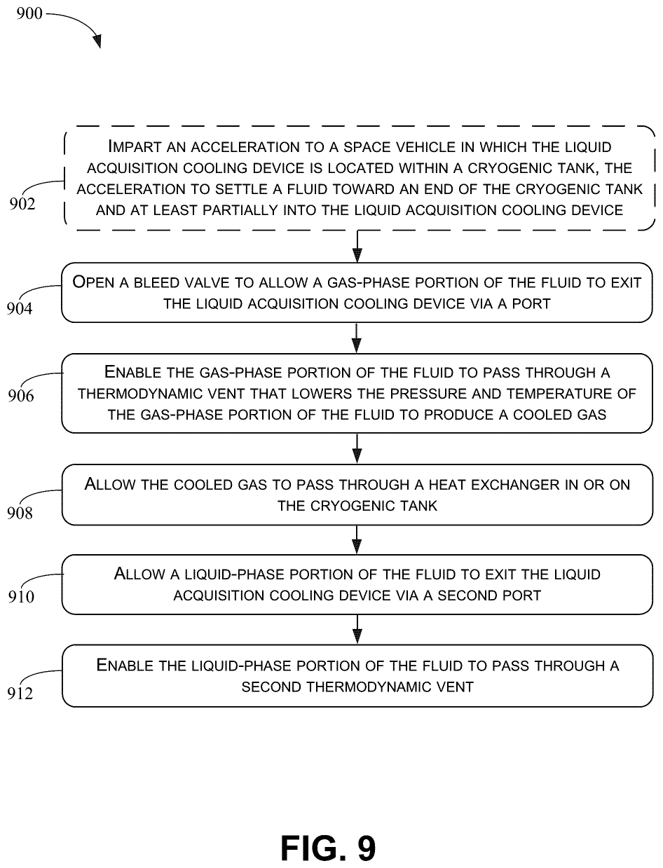

FIG. 9 is a flow diagram of a process 900 of operating a liquid acquisition device, such as 104, in a low-gravity environment. For example, the process may be performed by an operator such as a crew member, an electronic controller, a computer processing system following computer-executable instructions, or a combination thereof.

In an example application that need not involve process 900, when in space (or other micro-gravity situation) and liquid acquisition device 104 is full of fluid 117. preferentially in a liquid phase, the fluid may flow into port 121 and into liquid line 121A. Flow continues through at least one of TVS valves 126 and thermodynamic vents 124 (e.g., Joule Thomson throttling “orifices”). Because the liquid acquisition device is full, port 121 will draw in the liquid phase of the fluid. Flow from port 121 through a TVS valve and a thermodynamic vent leads to a decrease in pressure and temperature of the fluid flow. The fluid then flows through one or more heat exchangers (e.g., 134A, 134B, 136) where it changes phase while cooling fluid 117 in tank 102. The fluid may then be vented out to space. Generally, phase change is a much better process for transferring heat compared to just sensible heat transfer. During this time when the liquid acquisition device is full, fluid may be drained via the top bleed line (e.g., 122A) for producing results that are the same as or similar to draining via the liquid line: In both cases, fluid passes through junction 137 after traversing a TVS valve (e.g., 126 or 130) and a thermodynamic vent (e.g., 124 or 128).

In an example application that may involve at least some portions of process 900. when in space (or other micro-gravity situation) and the liquid acquisition device contains fluid in the liquid and gas phases (e.g., gas having been “pushed” through screens 202 and 206 into the liquid acquisition device), port 121 may draw in the liquid phase of fluid 117, which subsequently traverses at least one of thermodynamic vents 124. However, port 121 may also draw in the gas phase of the fluid. If this happens, the cooling rate of the thermodynamic vent(s) will drop since there is no boiling of the already-gaseous fluid. At some point, process 900 may include deciding to refill the liquid acquisition device, which may lead to settling of the fluid. Propellant may be settled to bring it down toward the bottom of tank 102 in a region surrounding the liquid acquisition device. Bleed line 122A may then be used by opening valve 130 to allow fluid flow through thermodynamic vent 128 and subsequently out to space. Preferentially, the gas phase of fluid 117 will be in the upper region in the liquid acquisition device, but there may also be liquid in the same region. In general, bleed line 122A (via port 122) may draw in the gas from the liquid acquisition device if allowed to operate for a while. This may result in reduced heat transfer (e.g., because of the presence of the gas phase versus the liquid phase) in thermodynamic vent 128 during the bleed process until the liquid acquisition device becomes fully reprimed with liquid. At that point, settling may be stopped and the process may switch back to using the liquid line (e.g., 121A via port 121) to lead to flow into thermodynamic vent(s) 124. Generally, in some implementations, fluid may be maintained to be above about 40% liquid in tank 102 while in space. That relatively high fill level may allow for a “partial communication” liquid acquisition device concept to operate when it is covered with a relatively large proportion of liquid. Thus, in these implementations, gas need not be bled into space and settling via rocket thrusters need not occur.

In some implementations, the bleed line (e.g., 122A) may be involved in a process of filling tank 102. During filling, bubbles in the fluid will generally hang up (e.g., temporarily trapped) in the liquid acquisition device. The operator may bleed the bubbles (e.g., the gas phase of fluid 117) out the liquid acquisition device via port 122 and line 122A during tank filling. Thermodynamic vent 128 may perform some cooling at this time.

In yet another example application that involves process 900, when in space (or other micro-gravity situation), 902 is an optional step that may be used to settle fluid toward a “bottom” of a tank and into a liquid acquisition device. In particular, at 902, the operator may impart an acceleration to a space vehicle in which the liquid acquisition device is located within a cryogenic tank. The acceleration tends to settle a fluid toward an end of the cryogenic tank and at least partially into the liquid acquisition device. At 904, the operator may open a bleed valve to allow a gas-phase portion of the fluid to exit the liquid acquisition device via a port. At 906, the operator may enable the gas-phase portion of the fluid to pass through a primary thermodynamic vent that lowers the pressure and temperature of the gas-phase portion of the fluid to produce a cooled gas. At 908, the operator may allow the cooled gas to pass through a heat exchanger in or on the cryogenic tank. The cooled gas may also flow through another heat exchanger that is inside the liquid acquisition device. At 910, the operator may allow a liquid-phase portion of the fluid to exit the liquid acquisition device via a second port. At 912, the operator may enable the liquid-phase portion of the fluid to pass through a secondary thermodynamic vent, which may cool the fluid flowing therein. This cooled fluid may then pass through one or both of the heat exchangers mentioned above.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A liquid acquisition cooling system for operating in a low-gravity environment, the system comprising:
a cryogenic tank;
a liquid acquisition device in the cryogenic tank and comprising a toroid-shaped enclosure having a top facing a central portion of the cryogenic tank and a bottom that is opposite the top;
a high-flow fluid port coincident with the central axial opening of the toroid-shaped enclosure and configured to provide fluid from the cryogenic tank to an external device that consumes the fluid as a fuel or oxidizer;
screens having pores that are sized to substantially prevent flow of a gas phase of the fluid and to allow flow of a liquid phase of the fluid, wherein the screens are positioned around at least a portion of an outer perimeter of the toroid-shaped enclosure, and wherein the fluid in the cryogenic tank enters the enclosure via the screens;
a first exit port in the enclosure at or near the bottom of the enclosure, the first exit port configured to draw the fluid substantially in the liquid phase from the enclosure;
a primary thermodynamic vent to receive the fluid substantially in the liquid phase from the first exit port; and
a second exit port in the enclosure at or near the top of the enclosure, the second exit port configured to draw the fluid substantially in the gas phase from the enclosure.

2. The system of claim 1, further comprising a secondary thermodynamic vent to receive the fluid substantially in the gas phase from the second exit port.

3. The system of claim 2, further comprising a bleed valve upstream from the secondary thermodynamic vent.

4. The system of claim 1, further comprising a bleed valve to receive the fluid substantially in the gas phase from the second exit port.

5. The system of claim 1, wherein the primary thermodynamic vent reduces the pressure and temperature of the fluid substantially in the liquid phase from the first exit port to produce a cooled fluid.

6. The system of claim 5, further comprising a first heat exchanger in or on the cryogenic tank to receive the cooled fluid from the primary thermodynamic vent.

7. The system of claim 6, further comprising a second heat exchanger in the enclosure to receive the cooled fluid from the primary thermodynamic vent, wherein the first heat exchanger is downstream from the second heat exchanger.

8. The system of claim 1, wherein the primary thermodynamic vent comprises a Joule-Thompson throttling device or a cryocooler.

9. The system of claim 1, wherein the liquid acquisition device further comprises antivortex wing vanes protruding into the cryogenic tank from the toroid-shaped enclosure.

10. The system of claim 1, wherein the liquid acquisition device further comprises an antivortex/vapor ingestion suppressor in the central axial opening of the toroid-shaped enclosure and between the high-flow fluid port and the central portion of the cryogenic tank.

11. The system of claim 1, wherein the screens are substantially flat.

12. A liquid acquisition device for operating in a low-gravity environment, the device comprising:
a toroid-shaped enclosure, wherein the central opening of the toroid-shaped enclosure comprises a high-flow fluid port to provide fluid from a cryogenic tank to an external device that consumes the fluid as a fuel or oxidizer;
screens having pores that are sized to substantially prevent flow of a gas phase of the fluid and to allow flow of a liquid phase of the fluid, wherein the screens are positioned around at least a portion of an outer perimeter of the toroid-shaped enclosure, and wherein the fluid in the cryogenic tank enters the enclosure via the screens;
a primary thermodynamic vent configured to receive the fluid substantially in the liquid phase from the enclosure;
a secondary thermodynamic vent configured to receive the fluid substantially in the gas phase from the enclosure; and
a bleed valve downstream from the secondary thermodynamic vent to bleed the fluid substantially in the gas phase from the enclosure.

13. The device of claim 12, further comprising a first heat exchanger configured to immerse into a cryogenic fluid and to receive cooled fluid from the primary thermodynamic vent.

14. The device of claim 13, further comprising a second heat exchanger in the enclosure to receive the cooled fluid from the primary thermodynamic vent, wherein the first heat exchanger is downstream from the second heat exchanger.

15. The device of claim 12, wherein the primary and the secondary thermodynamic vents comprise a Joule-Thompson throttling device or a cryocooler.

16. The device of claim 12, further comprising a ring-shaped conduit to collect the fluid substantially in the liquid phase within the enclosure, wherein the ring-shaped conduit is substantially concentric with a perimeter of the toroid-shaped enclosure and at or near a bottom of the enclosure.

17. The device of claim 16, further comprising a second ring-shaped conduit to collect the fluid substantially in the gas phase within the enclosure, wherein the second ring-shaped conduit is substantially concentric with the perimeter of the toroid-shaped enclosure and at or near a top, opposite the bottom, of the enclosure.

18. A method of operating a liquid acquisition device located in a cryogenic tank in a low-gravity environment, the method comprising:
opening a bleed valve to allow a gas-phase portion of a fluid in the liquid acquisition device to exit the liquid acquisition device via a port; and
enabling the gas-phase portion of the fluid to pass through a primary thermodynamic vent that lowers the pressure and temperature of the gas-phase portion of the fluid to produce a cooled gas.

19. The method of claim 18, further comprising allowing the cooled gas to pass through a heat exchanger in or on the cryogenic tank.

20. The method of claim 18, further comprising:
allowing a liquid-phase portion of the fluid to exit the liquid acquisition device via a second port; and
enabling the liquid-phase portion of the fluid to pass through a secondary thermodynamic vent.
